(19) United States
(12) Patent Application Publication
(10) Pub. No.: US 2023/0313009 A1
(43) Pub. Date: Oct. 5, 2023

(54) ABRASIVE COMPRISING a-ALUMINA PARTICLES AND PREPARATION METHOD THEREFOR

(71) Applicant: TCERA CO., LTD., Gyeonggi-do (KR)

(72) Inventors: Jin Su LEE, Gyeonggi-do (KR); Jeonghwan KIM, Gyeonggi-do (KR); Dong Kyun KIM, Gyeonggi-do (KR)

(21) Appl. No.: 18/022,678

(22) PCT Filed: Sep. 16, 2021
(86) PCT No.: PCT/KR2021/012686

§ 371 Date: Feb. 22, 2023

(30) Foreign Application Priority Data
Oct. 7, 2020 (KR) 10-2020-0129674

(51) Int. Cl. C09K 3/14; C01F 7/04; B01J 6/00

(52) U.S. Cl. CPC C09K 3/1409; C01F 7/04; B01J 6/001; C01P 2002/30; C01P 2006/80

(57) ABSTRACT

The present invention provides an abrasive comprising α-alumina particles having a polyhedral crystal structure, wherein the α-alumina particles have an average diameter (D50) of 300 nm to 10 μm and a bulk density of 0.2-0.5 g/mL, a [0001] face in the crystal structure of the α-alumina particles occupies 10-20% on the basis of the total crystal face area, and the amount of α-alumina particles is 85-100 wt % on the basis of the total weight. The abrasive of the present invention comprises α-alumina particles satisfying predetermined particle size and density ranges while having a polyhedral crystal structure, and thus provides excellent dispersibility in a polishing slurry to enable a polishing rate to increase, while minimizing scratch formation during polishing.

### TECHNICAL FIELD

This application claims the benefit of priority from Korean Patent Application No. 10-2020-0129674, filed on Oct. 7, 2020, the entire disclosure of which is incorporated by reference herein.

The present invention relates to an abrasive containing α-alumina particles having a polyhedral crystal structure capable of improving polishing efficiency and a manufacturing method thereof.

### BACKGROUND ART

Alumina (Al₂O₃) is excellent in mechanical strength such as wear resistance, chemical stability, thermal conductivity, heat resistance, etc., and is used in a wide range of areas such as abrasives, electronic materials, heat dissipation fillers, optical materials, and biomaterials. Alpha-alumina is mainly used in the polishing process to flatten the surface and edges of ultra-thin glass to be used as parts of electronic devices such as OLED, PDP, LCD, and mobile phones. In order to improve the polishing rate, it is necessary to control physical properties such as particle shape and size of α-alumina used as an abrasive.

Alumina can generally be produced using bauxite as a raw material. For example, according to the Bayer process, alumina powder is produced by first obtaining aluminum hydroxide (gibbsite) or transitional alumina from bauxite as a raw material and then calcining it in the air. However, alumina produced by the Bayer process is difficult to control the shape and size of its particles and is not suitable for all applications.

On the other hand, Korean Patent Publication No. 10-2014-0130049 (Merck Patent GMBH) discloses that aluminum hydroxide particles are obtained by adding an alkali metal salt (e.g., sodium sulfate, potassium sulfate) as a mineralizer to an aqueous solution or slurry of an aluminum salt, where α-Al₂O₃ flakes are prepared by adding a phosphorus compound and at least one dopant and then calcining them, and that it is characterized that α-Al₂O₃ flakes have a thickness of less than 0.5 μm and a D₅₀ value of 15 to 30 μm. Alpha-alumina having said particle size and thickness forms plate-like alumina particle with a large aspect ratio (diameter/thickness ratio). When used as an abrasive, these plate-like particles have a high risk of scratching and are settled down in the slurry, resulting in poor dispersibility and making it not suitable for polishing processes of parts of electronic devices such ultra-thin glass.

Therefore, in order to use an alumina material for polishing a thin film, etc., there is a need for improving dispersibility in a polishing slurry while realizing the shape and size of particles which can reduce the occurrence of scratches.

### DETAILED DESCRIPTION OF THE INVENTION

### Technical Problem

An object of the present invention is to provide an abrasive containing α-alumina particles having a crystal structure and physical properties capable of improving polishing efficiency due to excellent dispersibility in a polishing slurry while minimizing the occurrence of scratches, and a manufacturing method thereof.

### Solution to Problem

One aspect of the present invention is to provide an abrasive comprising α-alumina particles having a polyhedral crystal structure, wherein the α-alumina particles have an average diameter (D50) of 300 nm to 10 μm and a bulk density of 0.2 to 0.5 g/mL, the area of a [0001] face in the crystal structure of the α-alumina particles represents 10 to 20% of the total crystal face area, and the amount of α-alumina particles is 85-100 wt % on the basis of the total weight.

Another aspect of the present invention is to provide a method for preparing the abrasive comprising α-alumina particles as described above, comprising:
(S1) reacting by mixing an aqueous solution containing one or more aluminum salts with an aqueous solution containing a pH adjusting agent, and then filtering and drying them to obtain a precursor powder of structural formula 1 below;
(S2) adding to a dispersion medium the precursor powder together with a fluorine-based mineralizer and stirring them; and
(S3) filtering and drying the product of step (S2) and then calcining it to obtain a powder of α-alumina particles having a polyhedral crystal structure:

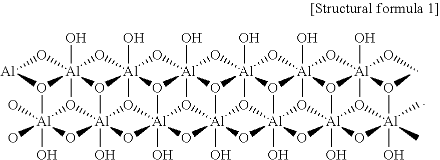

Another aspect of the present invention is to provide a polishing method comprising polishing ultra-thin glass to be used as a part of an electronic device using the abrasive containing α-alumina particles as described above.

### Effect of the Invention

The abrasive of the present invention comprises α-alumina particles satisfying predetermined particle size and density ranges while having a polyhedral crystal structure, and thus provides excellent dispersibility in a polishing slurry to enable a polishing rate to increase, while minimizing scratch formation during polishing.

### BRIEF DESCRIPTION OF DRAWINGS

FIG. 1 is a scanning electron microscope (SEM) photograph of α-alumina particles prepared in Example 1.

FIG. 2 shows the results of X-ray diffraction analysis (XRD) of α-alumina particles prepared in Example 1.

### BEST MODE FOR CARRYING OUT THE INVENTION

The present invention may have various modification and various embodiments and specific embodiments will be illustrated in the drawings and described in detail. However, this is not intended to limit the present invention to specific embodiments, and should be understood to include all modifications, equivalents, and substitutes included in the spirit and scope of the present invention. In describing the present invention, if it is determined that a detailed description of a related known technology may obscure the gist of the present invention, the detailed description thereof will be omitted.

Hereinafter, the present invention will be described in more detail.

One embodiment of the present invention relates to an abrasive containing α-alumina particles having a polyhedral crystal structure.

The α-alumina particles having a polyhedral crystal structure have a shape close to spherical, meaning that the ratio (D/H) of the diameter (D) perpendicular to the [0001] face, which is crystallographically C plane, to the height (H), is close to 1, for example.

In particular, the α-alumina particles according to the present invention may have a tetradecagonal (14-face) crystal structure in which the area of the [0001] face in the crystal structure of the α-alumina particles represents 10 to 20%, specifically 15 to 20% of the total crystal face area. If it is less than 10%, the α-alumina particles are in the form of a rod, and if it exceeds 20%, the α-alumina particles have a shape close to plate.

When used as an abrasive, α-alumina particles having a polyhedral crystal structure with a shape close to spherical can improve polishing performance by minimizing the occurrence of scratches compared to plate-like or amorphous particles. The ‘amorphous’ indicates an irregular state with non-uniform appearance and is distinguished from a polyhedral crystal structure having an obvious crystal face of the present invention.

In addition, the α-alumina particles of the polyhedral crystal structure are characterized by an average particle diameter (D₅₀) of 300 nm to 10 μm and a bulk density of 0.2 to 0.5 g/ ml.

The D₅₀ is a medium value of particle size distribution as measured by a conventional method in the art, for example, a laser diffraction particle size analyzer, and in the present invention, the D₅₀ of the α-alumina particles can have a micronized level of 300 nm to 10 μm. As a result, polishing efficiency can be improved by imparting a desired polishing rate while minimizing scratch formations during polishing.

The density can be measured using a conventional method in the art, for example, from mass and volume required to fill a 100 ml measuring cylinder. In the present invention, when the α-alumina particles satisfy the density of 0.2 to 0.5 g/ml, they are uniformly dispersed without settling down in the polishing slurry, improving polishing efficiency.

The abrasive according to the present invention contains 85% by weight or more, such as 85 to 100% by weight of α-alumina particles exhibiting the above physical properties based on the total weight. When the content of the α-alumina particles is less than 85% by weight, it is difficult to secure a desired polishing rate during polishing.

In addition, the abrasive according to the present invention can be used for polishing in the form of water-dispersed slurry. The slurry in which the abrasive is dispersed in water may have a viscosity in the range of 1 to 10 pcs, specifically 1 to 5 pcs. When the above range is satisfied, it is possible to maintain a balance between uniform dispersion of α-alumina particles and the improved polishing efficiency.

Another aspect of the present invention relates to a method for preparing the abrasive comprising α-alumina particles having a polyhedral crystal structure as described above. Hereinafter, the method is described for each step.

First, an aqueous solution containing one or more aluminum salts and an aqueous solution containing a pH adjusting agent are mixed and reacted (S1).

The aluminum salt may include aluminum sulfate (Al₂(SO₄)₃.4˜18H₂O), aluminum nitrate (Al(NO₃)₃.9H₂O), aluminum acetate (Al(CHCOO)₃OH) or mixtures thereof. An aqueous solution is prepared by dissolving in warm water (e.g., about 60° C.) at a concentration of 5% to 30% for complete dissolution.

The pH adjusting agent may include sodium carbonate (Na₂CO₃), sodium hydroxide (NaOH), potassium hydroxide (KOH), calcium carbonate (CaCO₃) or a mixture thereof. An aqueous solution is prepared by dissolving in warm water (e.g., about 40° C.) at a concentration of 5% to 30% for complete dissolution.

A sol-gel reaction may be performed by mixing the aqueous solution of aluminum salt and the aqueous solution of the pH adjuster at a constant rate (e.g., 25 ml/min) at room temperature to 95° C. The pH of the reactant may be in the range of 6 to 10.

Through this reaction, a precursor of structural formula 1 below is produced:

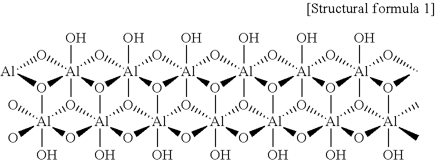

The precursor of structural formula 1 is pseudo-boehmite with the chemical composition AlO(OH), which has a high water content because water (H₂O) is bound in an octahedral unit cell, and therefore has a small crystallite size.

These precursors can be formed under low pH conditions compared to aluminum hydroxide (Al(OH)₃), which was mainly used as a starting material in conventional alumina production. When the precursor is transformed into α-Al₂O₃ through a high-temperature calcining process, particle aggregation by seeds and phase transition occur at a relatively low temperature, which is advantageous in obtaining a polyhedral crystal structure.

The precursor is produced as a solid, which is filtered, washed and dried to obtain a powder.

Additionally, the powder obtained can be used in a subsequent step after the pulverization process. The pulverization may be performed in a ball-mill dry pulverization to provide a powder having a size of 300 nm to 20 μm.

Subsequently, the precursor powder is added to a dispersion medium together with a fluorine-based mineralizer and stirred (S2).

The fluorine-based mineralizer is an additive for growing crystals of α-alumina particles, and LiF₂, AlF₃, NaF, NaPF₆, K₂TiF₆, or a mixture thereof may be used.

When used in excess, the fluorine-based mineralizer may remain in the final α-alumina or form agglomerates in the process of calcination. In order to minimize such disadvantages, it is advantageous to use the precursor powder and the fluorine-based mineralizer in a weight ratio of 100:0.1 to 100:2, specifically 100:0.5 to 100:1.5.

The dispersion medium is for wet dispersion of the precursor powder and the fluorine-based mineralizer, and for example, ethanol, methanol, acetone, isopropyl alcohol, or a mixture thereof may be used. The wet dispersion promotes uniform dispersion of the fluorine-based mineralizer and minimizes aggregation of the precursor (pseudo-bohemite) particles, thereby affecting the polyhedral crystal structure of the final α-alumina particles.

The dispersion medium may be used in an amount of 2 to 5 times the weight of the precursor powder, but it is not limited thereto.

The stirring may be performed for 20 to 60 minutes for uniform mixing of the precursor powder and the fluorine-based mineralizer.

After stirring, the product is filtered, dried and calcined to obtain powder of α-alumina particles having a polyhedral crystal structure (S3).

The calcination is a process of melt synthesis by heat-treating the dry powder composed of the precursor powder and the fluorine-based mineralizes at a high temperature, and it may be performed in a crucible made of high purity alumina or zirconia.

Specifically, the calcination may be performed by raising the temperature at a rate of 3 to 15° C./min and then maintaining the temperature at 800° C. to 1000° C. for 2 to 5 hours. On the other hand, the calcining condition can be appropriately changed in consideration of the reactivity between the components of the mixture and volatility due to the melting point difference, and the amount of heat required for synthesis.

Through the above process, the α-alumina particles especially prepared using the pseudo-boehmite precursor of structural formula 1 contain 98.5% by weight or more of the Al component as determined by XRF (X-ray fluorescence) analysis and thus have high purity.

Moreover, as described above, the α-alumina particles have a polyhedral crystal structure with a ratio of [0001] face of 10 to 20% and have an average particle diameter (D₅₀) of 300 nm to 10 μm and a density (bulk density) of 0.2 to 0.5 g/ml. Thereby, the abrasive containing 85% by weight or more of the particles minimizes the occurrence of scratches and has excellent dispersibility in the polishing slurry, thereby improving polishing efficiency.

For example, when ultra-thin glass to be used as a part of an electronic device is polished for 60 seconds at a pressure of 3.5 psi by supplying the α-alumina particle abrasive in the form of water-dispersed slurry at a rate of 150 ml/min, the polishing rate measured by the difference in thin-film thickness before and after polishing is in the range of 4000 to 8000 Å/min.

### Mode for Carrying Out the Invention

Hereinafter, embodiments of the present invention will be described in detail so that those of ordinary skill in the art can easily carry out the present invention. However, the present invention may be embodied in several different forms and is not limited to the embodiments described herein.

### EXAMPLE 1

An aqueous solution (a) in which 199.8 g of Al₂(SO₄)₃ 14˜18H₂O was completely dissolved in 982.8 g of pure water heated to 60° C. and an aqueous solution (b) in which 95.4 g of Na₂CO₃ was completely dissolved in 528 g of pure water heated to 40° C. were prepared. The aqueous solution (b) was added to the aqueous solution (a) at a rate of 25 ml; min, followed by stirring for 10 minutes to react. The reaction product (pH 7.3-7.8) was filtered, washed, dried, and then pulverized to obtain a powder of pseudo-boehmite precursor.

40 g of the precursor powder and 0.2 g of AlF₃ were mixed in 120 g of ethanol and stirred for 30 minutes.

Thereafter, the resulting product was filtered and dried, and then calcined by heat treatment at 900° C. for 5 hours at a heating rate of 1° C./min. After heat treatment, a powder of α-alumina particles was finally obtained.

### EXAMPLE 2

The same process as in Example 1 was performed except that AlF₃ was used in an amount of 0.4 g.

### EXAMPLE 3

The same process as in Example 1 was performed except that AlF₃ was used in an amount of 0.6 g.

### COMPARATIVE EXAMPLE 1

40 g of Al(OH)₃ powder and 0.2 g of AlF₃ were dry mixed. The mixed powder was calcined by heat treatment at 900° C. for 5 hours at a heating rate of 10° C./min. After heat treatment, a powder of α-alumina particles was finally obtained.

### COMPARATIVE EXAMPLE 2

The same process as in Comparative Example 1 was performed except that AlF₃ was used in an amount of 0.4 g.

### COMPARATIVE EXAMPLE 3

The same process as in Comparative Example 1 was performed except that. AlF₃ was used in an amount of 0.8 g.

### COMPARATIVE EXAMPLE 4

The same process as in Comparative Example 1 was performed except that AlF₃ was used in an amount of 1.6 g.

### COMPARATIVE EXAMPLE 5

40 g of Al(OH)₃ powder and 0.2 g of AlF₃ were mixed in 120 g of ethanol and stirred for 30 minutes. The resulting product was calcined by heat treatment at 900° C. for 5 hours at a heating rate of 10° C./min. After heat treatment, a powder of α-alumina particles was finally obtained.

### COMPARATIVE EXAMPLE 6

The same process as in Comparative Example 5 was performed except that AlF₃ was used in an amount of 0.3 g.

### COMPARATIVE EXAMPLE 7

The same process as in Comparative Example 5 was performed except that AlF₃ was used in an amount of 2 g.

### EXAMPLE 4

An aqueous solution (a) in which 199.8 g of Al₂(SO₄)₃ 14˜H₂O was completely dissolved in 982.8 g of pure water heated to 60° C. and an aqueous solution (b) in which 72 g of NaOH was completely dissolved in 528 g of pure water heated to 40° C. were prepared. The aqueous solution (b) was added to the aqueous solution (a) at a rate of 25 ml/min, followed by stirring for 10 minutes to react. The reaction product (pH 7.3-7.8) was filtered, washed, dried, and then pulverized to obtain a powder of pseudo-boehmite precursor.

40 g of the precursor powder and 0.2 g of AlF₃ were mixed in 120 g of ethanol and stirred for 30 minutes.

Thereafter, the resulting product was filtered and dried, and then calcined by heat treatment at 900° C. for 5 hours at a heating rate of 10° C./min, After heat treatment, a powder of α-alumina particles was finally obtained.

### COMPARATIVE EXAMPLE 8

An aqueous solution (a) in which 199.8 g of Al₂(SO₄)₃ 14˜18H₂O was completely dissolved in 982.8 g of pure water heated to 60° C. and an aqueous solution (b) in which 72 g of NaOH was completely dissolved in 528 g of pure water heated to 40° C. were prepared. The aqueous solution (b) was added to the aqueous solution (a) at a rate of 25 ml/min, followed by stirring for 10 minutes to react. The reaction product (pH 7.3-7.8) was filtered, washed, dried, and then pulverized to obtain a powder of pseudo-boehmite precursor.

40 g of the precursor powder and 0.2 g of AlF₃ were dry mixed. The mixed powder was calcined by heat treatment at 900° C. for 5 hours at a heating rate of 10° C./min. After heat treatment, a powder of α-alumina particles was finally obtained.

### COMPARATIVE EXAMPLE 9

The same process as in Comparative Example 8 was performed except that AlF₃ was used in an amount of 0.4 g.

### COMPARATIVE EXAMPLE 10

The same process as in Comparative Example 8 was performed except that AlF₃ was used in an amount of 0.8 g.

### COMPARATIVE EXAMPLE 11

The same process as in Comparative Example 8 was performed except that AlF₃ was used in an amount of 1.6 g.

The physical properties of the α-alumina particles prepared Examples and Comparative Examples were determined. The results are shown in Table 1 below.

TABLE 1

| | | | | | Results | | | |
|---|---|---|---|---|---|---|---|---|
| | | Preparation condition | | | Morphology | | | |
| | | Raw | Mixing | Precursor: AlF₃ | (crystal | D₅₀¹⁾ | Thickness²⁾ | Density³⁾ |
| | | material | mode | (weight ratio) | structure) | (μm) | (μm) | (g/ml) |
| Ex. | 1 | Pseudo- | Wet | 100:0.5 | Polyhedron | 1.9 | 1.9 | 0.36 |
| | 2 | boehmite | | 100:1.0 | Polyhedron | 1.7 | 1.7 | 0.35 |
| | 3 | | | 100:1.5 | Polyhedron | 1.6 | 1.6 | 0.38 |
| | 4 | | | 100:1.0 | Polyhedron | 2.0 | 2.0 | 0.35 |
| | | | | | ([0001] face | | | |
| | | | | | 15~20%) | | | |
| Comp. | 1 | Al(OH)₃ | Dry | 100:0.5 | Amorphous particle | | | 0.56 |
| Ex. | 2 | | Dry | 100:1.0 | Plate-like | 10.0 | 1.3 | 0.61 |
| | 3 | | Dry | 100:2.0 | Plate-like | 10.0 | 0.4 | 0.61 |
| | 4 | | Dry | 100:4.0 | Plate-like | 10.0 | 0.4 | 0.62 |
| | 5 | | Wet | 100:0.2 | Amorphous particle | | | 0.55 |
| | 6 | | Wet | 100:0.75 | Plate-like | 6.0 | 0.7 | 0.61 |
| | 7 | | Wet | 100:5.0 | Plate-like | 15.0 | 1.6 | 0.62 |
| | 8 | Pseudo- | Dry | 100:0.5 | Amorphous particle | | | 0.55 |
| | 9 | boehmite | Dry | 100:1.0 | Amorphous particle | | | 0.56 |
| | 10 | | Dry | 100:2.0 | Plate-like | 3.6 | 0.5 | 0.63 |
| | 11 | | Dry | 100:4.0 | Plate-like | 3.5 | 0.5 | 0.62 |

¹⁾D₅₀ was measured using a particle distribution analyzer CILAS 1090.
²⁾Thickness was measured by image analysis after selecting a plurality of particles from SEM images.
³⁾Density was determined using mass and volume required to fill a 100 ml measuring cylinder.

As can be seen in Table 1, the α-alumina particles prepared by wet mixing pseudo-boehmite with a fluorine-based mineralizer and then calcining have a polyhedral crystal structure with a ratio of D₅₀ to thickness close to 1, while D₅₀ of 300 nm to 10 μm and a bulk density of 0.2 to 0.5 g/ml were satisfied.

### EXPERIMENTAL EXAMPLE 1

### Evaluation of Crystal Plane and Purity of α-Alumina Particles

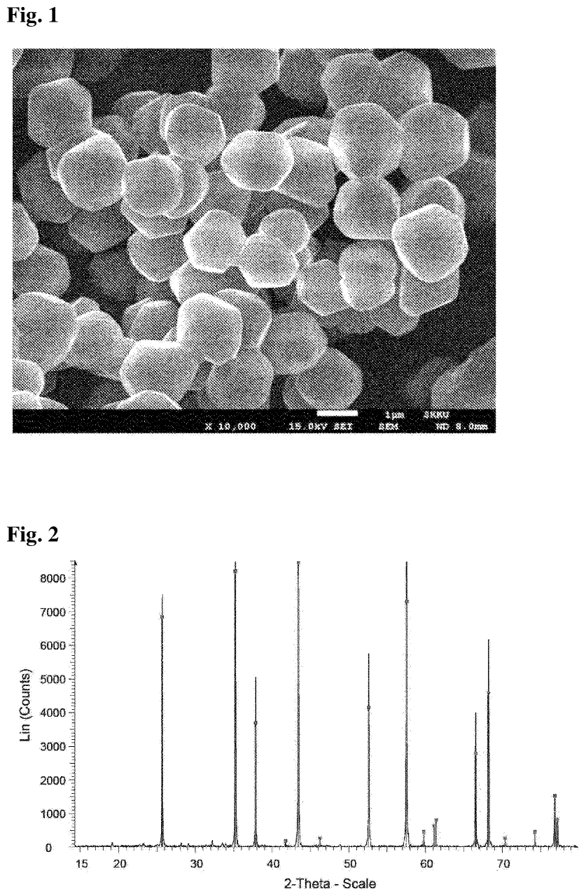

A scanning electron microscopy (SEM) observation result of α-alumina particles having a polyhedral crystal structure prepared in Example 1 is shown in FIG. 1.

From the SEM image of FIG. 1, it can be confirmed that the α-alumina particles of Example 1 exhibit a tetradecagonal crystal structure. in addition, as a result of SEM image analysis, it was confirmed that the area of the c-plane (0001 plane) in the crystal structure was 15 to 20% of the total area.

In addition, X-ray diffraction analysis (XRD) and X-ray fluorescence analysis (XRF) were performed on the α-alumina particles of Example 1, and the results are shown in FIG. 2 and Table 2, respectively.

TABLE 2

| Element | | Conc. | | | |
|---|---|---|---|---|---|
| Component | Z | (wt %)¹⁾ | State | Line 1 | Net int. |
| Al | 13 | 98.75 | XRF 1 | Al KA1-HR-Tr | 43.22 |
| S | 16 | 0.51 | XRF 1 | S KA1-HR-Tr | 0.2375 |
| Na | 11 | 0.4 | XRF 1 | Na KA1-HR-Tr | 0.09316 |
| Ca | 20 | 0.24 | XRF 1 | Ca KAI-HR-Tr | 0.1213 |
| Fe | 26 | 0.089 | XRF 1 | Fe KA1-HR-Tr | 0.2564 |

¹⁾Concentration calculated based on 100% of the sum of five components.

From Table 2 and FIG. 2, it can be confirmed that the α-alumina particles of Example 1 contain 98.5% by weight or more of Al component, and thus have high purity.

In addition, the results of ICP-OES (Inductively Coupled Plasma Optical Emission Spectrometry) analysis on the α-alumina particles of Example 1 are shown in Table 3 below.

TABLE 3

| Test item | Unit | Test method | Detection limit | Test result |
|---|---|---|---|---|
| Al (Aluminum) | — | — | — | Base |
| Ca (Calcium) | mg/L | ICP-OES | — | 151 |
| Si (Silicon) | mg/L | ICP-OES | — | 139 |
| Mg (Magnesium) | mg/L | ICP-OES | — | 79.7 |
| Fe (Iron) | mg/L | ICP-OES | — | 54.8 |
| Na (Sodium) | mg/L | ICP-OES | — | 35.3 |
| B (Boron) | mg/L | ICP-OES | — | 30.9 |
| K (Potassium) | mg/L | ICP-OES | — | 12.9 |
| Sb (Antimony) | mg/L | ICP-OES | 0.5 | Not detected |
| As (Arsenic) | mg/L | ICP-OES | 0.1 | Not detected |
| Ba (Barium) | mg/L | ICP-OES | 0.1 | Not detected |
| Be (Beryllium) | mg/L | ICP-OES | 0.1 | Not detected |
| Cd (Cadmium) | mg/L | ICP-OES | 0.1 | Not detected |
| Co (Cobalt) | mg/L | ICP-OES | 0.1 | Not detected |
| Cr (Chromium) | mg/L | ICP-OES | 0.1 | Not detected |
| Cu (Copper) | mg/L | ICP-OES | 0.1 | Not detected |
| Ga (Gallium) | mg/L | ICP-OES | 0.1 | Not detected |
| Ge (Germanium) | mg/L | ICP-OES | 0.1 | Not detected |
| In (Indium) | mg/L | ICP-OES | 0.1 | Not detected |
| Li (Lithium) | mg/L | ICP-OES | 0.1 | Not detected |

From the above Table 3, it can be confirmed that the α-alumina particles of Example 1 have high purity.

### EXPERIMENTAL EXAMPLE 2

### Evaluation of Polishing Rate

An experiment was performed to compare the polishing rate of the α-alumina particles having tetradecagonal structure ([0001] plane of 15-20%) of Example 1 with those of other companies having other shapes.

Specifically, a slurry (solid content: 40 to 45% by weight) was prepared in which each abrasive to be compared was dispersed in water, and the surface of the glass (ultra-thin glass) was polished for 60 seconds at a pressure of 3.5 psi using an 8-inch polishing machine (AMAT Mirra™) Here, the polishing slurry was supplied at a rate of 150 mL/min, and the rotation speed of the wafer head of the upper plate was 100 rpm and the rotation speed of the lower plate was 110 rpm. In addition, a pad was “IC1000/suba IV stacked pad” from Rodel Co.

After polishing, the thickness of the polished film was compared with that before polishing to measure the polishing rate (Å/min.). The results are shown in Table 4 below.

TABLE 4

| | | | | Polishing |
|---|---|---|---|---|
| | Crystal | D50¹⁾ | Density | rate |
| Abrasive | structure | (μm) | (g/ml) | (Å/min) |
| DAW-01 (Denka) | Spherical | 1.64 | 0.46 | 2303.1 |
| AKP-3000 (Sumitomo) | Amorphous | 0.78 | 0.43 | 3408.6 |
| Example 1 | Tetradecagon | 2.23 | 0.35 | 7192.2 |

D₅₀ was measured using a particle distribution analyzer CILAS 1090.
Density was determined using mass and volume required to fill a 100 ml measuring cylinder.

From the above Table 4, the α-alumina particles of Example 1 which have a polyhedral crystal structure and satisfy a D50 of 300 nm to 10 μm and a bulk density of 0.2 to 0.5 g/ml simultaneously, achieved the best polishing rate.

On the other hand, the polishing rate according to the content of the α-alumina particles having tetradecagonal structure ([0001] plane of 15-20%) of Example 1 in the abrasive was compared, and the polishing process was performed as described above. The results are shown in Table 5 below.

TABLE 5

| | Content of α-alumina particles | Polishing rate |
|---|---|---|
| Abrasive | ([0001] plane of 15-20%) | (Å/min) |
| #1 | 85% | 7238.3 |
| #2 | 50% | 3981.1 |
| #3 | 10% | 1085.7 |

From the above Table 5, it can be confirmed that the higher (85% or more of the total abrasive) the ratio of α-alumina particles having 15 to 20% of the area of [0001] face, the higher the polishing rate.

As described above, specific parts of the present invention have been described in detail, and it is clear that these specific descriptions are only preferred embodiments for those of ordinary skill in the art to which the present invention pertains, and the scope of the present invention is not limited thereto. Accordingly, the substantial scope of the present invention will be defined by the appended claims and their equivalents.

1. An abrasive comprising α-alumina particles having a polyhedral crystal structure,
wherein the α-alumina particles have an average diameter (D₅₀) of 300 nm to 10 μm and a bulk density of 0.2 to 0.5 g/mL,
the area of a [0001] face in the crystal structure of the α-alumina particles represents 10 to 20% of the total crystal face area, and
the amount of α-alumina particles is 85 to 100 wt % on the basis of the total weight.

2. The abrasive according to claim 1, wherein the polyhedral crystal structure of the α-alumina particles includes a tetradecagonal crystal structure.

3. The abrasive according to claim 1, wherein the ratio of the [0001] face in the polyhedral crystal structure of the α-alumina particles to the total crystal face area is 15 to 20%.

4. A method for preparing the abrasive comprising α-alumina particles according to claim 1, comprising:
(S1) reacting by mixing an aqueous solution containing one or more aluminum salts with an aqueous solution containing a pH adjusting agent, and then filtering and drying them to obtain a precursor powder of structural formula 1 below;
(S2) adding to a dispersion medium the precursor powder together with a fluorine-based mineralizer and stirring them; and
(S3) filtering and drying the product of step (S2) and then calcining it to obtain a powder of α-alumina particles having a polyhedral crystal structure:

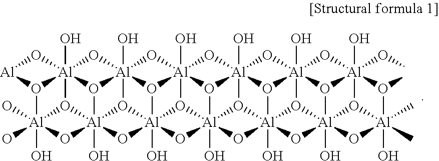

5. The method according to claim 4, wherein the aluminum salt used in step (S1) is aluminum sulfate (Al₂(SO₄)₃.4˜18H₂O), aluminum nitrate (Al(NO₃)₃.9H₂O), aluminum acetate (Al(CHCOO)₃OH) or mixtures thereof.

6. The method according to claim 4, wherein the pH adjusting agent used in step (S1) includes sodium carbonate (Na₂CO₃), sodium hydroxide (NaOH), potassium hydroxide (KOH), calcium carbonate (CaCO₃) or a mixture thereof.

7. The method according to claim 4, wherein the mixing in step (S1) is performed at room temperature to 95° C.

8. The method according to claim 4, wherein the precursor powder and the fluorine-based mineralizer in step (S2) are used in a weight ratio of 100:0.1 to 100:2.

9. The method according to claim 4, wherein the fluorine-based mineralizer in step (S2) includes LiF₂, AlF₃, NaF, NaPF₆, K₂TiF₆ or a mixture thereof.

10. The method according to claim 4, wherein the dispersion medium in step (2) includes ethanol, methanol, acetone, isopropyl alcohol or a mixture thereof.

11. The method according to claim 4, wherein the calcination in step (S3) is performed by raising the temperature at a rate of 3 to 15° C./min and then maintaining the temperature at 800° C. to 1000° C. for 2 to 5 hours.

12. The method according to claim 4, wherein the powder of α-alumina particles obtained in step (S3) contains 98.5% by weight or more of Al component as determined by XRF (X-ray fluorescence) analysis.

13. A polishing method comprising polishing ultra-thin glass to be used as a part of an electronic device using the abrasive containing α-alumina particles according to claim 1.

14. The method according to claim 13, wherein the polishing is performed for 60 seconds at a pressure of 3.5 psi by supplying the abrasive in the form of water-dispersed slurry at a rate of 150 ml/min, and the polishing rate measured by the difference in thin-film thickness before and after polishing is in the range of 4000 to 8000 Å/min.
